(19) United States
(12) Patent Application Publication
(10) Pub. No.: US 2008/0258904 A1
(43) Pub. Date: Oct. 23, 2008

(54) ALARM DEVICE AND SYSTEM

(76) Inventor: J. Darryl Moss, Alpharetta, GA (US)

Correspondence Address: GEORGE R. REARDON, 3356 STATION COURT, LAWRENCVILLE, GA, 30044, US

(21) Appl. No.: 11/745,499

(22) Filed: May 8, 2007

Related U.S. Application Data
(63) Continuation-in-part of application No. 11/738,253, filed on Apr. 20, 2007.

(51) Int. Cl. G08B 29/04

(52) U.S. Cl. 340/506

(57) ABSTRACT

An addressable alarm device capable of connecting to a non-addressable alarm device as well as to a polling alarm system is disclosed. A plurality of tandem non-addressable alarm devices has the last tandem non-addressable alarm device terminate in the addressable alarm device. In this configuration when one non-addressable alarm device activates all non-addressable alarm devices plus the addressable alarm device activate. When the polling alarm system polls the addressable alarm device the exact location of the alarm condition is identified.

This application claims the benefit of the filing date of and is a continuation-in-part of United States Utility Patent Application having a title of Fire Alarm System, filed on Apr. 20, 2007 and assigned Ser. No. 11/738,253, which is incorporated herein in its entirety.

### FIELD OF THE INVENTION

The present invention relates generally to alarm devices and systems, and more particularly to an alarm device and system for commercial and residential structures.

### BACKGROUND OF THE INVENTION

The invention pertains in general to alarm devices and systems and in particular to an addressable alarm device capable of connecting to one or more non-addressable alarm devices as well as to a polling alarm system, to form a hybrid alarm system of non-addressable devices linked to an addressable device which in turn is connected to a structure alarm system.

Devices to detect an alarm condition and to generate an alert exist. Depending on the device the alarm condition to be detected may include smoke, flame, heat, fire, carbon monoxide, Radon, water flow, as well as others. Some of these devices are non-addressable and generate an alert in the proximity of the detected alarm condition. Other devices are addressable and are systematically polled by a alarm system to determine if a normal or trouble condition exists. In general addressable devices are more expensive than non-addressable devices.

A fire alarm system, for example, is composed of components which can be classified into the following categories.
Initiating Devices—these devices either sense the effects of a fire, or are manually activated by personnel, resulting in a signal to the fire alarm panel. Examples are heat detectors, smoke detectors, manual pull stations, and sprinkler pressure or flow switches.
Main Fire alarm control (panel)—this is the central brain of the overall system, which coordinates the signals and resultant actions of the system.
Power supply—because one of the fire alarm system objectives is life safety, fire alarm system power supplies are redundant, and relatively very reliable as compared to electronic or electrical systems of similar complexities (e.g., HVAC control systems). Primary supply—Commercial light and power. Back-up/secondary supply—Usually sealed, lead-acid batteries. NAC power supplies for additional notification appliances beyond the original capability of the FACP. Generators are permitted under strict rules.
Notification appliances—these devices provide stimuli for initiating emergency action and provide information to users, emergency response personnel, and occupants. Examples are bell, horn, speaker, light, or text display that provides audible, tactile, or visible outputs.
Signaling line circuits (SLC)—the wiring which carries data information.
Supervisory signals—detecting devices and signaling to indicate a condition in fire protection systems which is not normal and could prevent the fire protection system from functioning as intended in the event of a fire. An example is a closed valve which controls the water supply to a fire sprinkler system. This does not indicate the failure of a component or subsystem of the fire alarm system.
Trouble signal—signaling to indicate a wiring fault. Sometimes specific components or features of the fire alarm system, f which could prevent the fire alarm or fire suppression system from functioning as intended. An example is a disconnected wire at a heat detector.
Remote annunciation—A usually alpha-numeric display (may be graphic) that indicates where in the building the alarm originated. It may also indicate the type of device. Used by emergency personnel for locating the fire quickly. Sometimes these will contain some control functions such as alarm silence and alarm reset. Must be key or keypad controlled.

Fire alarm systems have devices connected to them to detect the fire/smoke or to alert the occupants of an emergency. Below is a list of common devices found on a fire alarm.
Manual pull stations/manual call points—Devices to allow people to manually activate the fire alarm. Usually located near exits. Also called “manual pull boxes”.
Smoke detectors—Spot type: Photoelectric and Ionization; Line type: Projected Beam Smoke Detector; Air-Sampling type: Cloud Chamber
Water Flow Switches—Detect when water is flowing through the fire sprinkler system
Rate-of-Rise and Thermostat (heat) Detectors—Detect heat changes
Valve Supervisory Switch—Indicates that a fire sprinkler system valve that is required to be open, is now closed (off-normal).
Carbon Monoxide Detectors—Detects poisonous carbon monoxide gas and usually only connected to household fire alarm systems. Very rarely, commercial systems.
Horns/Strobes—Visual and Audible devices to alert people of system activation.
Magnetic Door Holder—Doors are allowed to close when the fire alarm is activated.

An audio evacuation system or voice evacuation system is a type of fire alarm notification system. In addition to, or in place of, sirens, horns, bells, and alarm tones, an audio evacuation system plays a voice message with evacuation instructions. These messages can be customized for various types of installations, and multi-lingual capabilities are usually available.

The rationale behind audio evacuation systems is, though conventional fire alarm notification devices alert occupants of a building of the presence of an emergency, they do not provide detailed information to the occupants, such evacuation routes or instructions. The problem lies in buildings where there are a large amount of frequently changing occupants who are not necessarily familiar with the locations of emergency exits or stairwells. These types of buildings are designated in model building codes as “areas of assembly”, such as buildings with a capacity of 300 or more people, but voice evacuation rules usually only apply when the occupant load exceeds 1000. Areas of assembly include churches, movie theaters, auditoriums, department stores, restaurants, shopping malls, and museums. Additionally, such a system is usually integrated with a fire telephone or paging system, which permits the fire department or building manager to give specific evacuation instructions pertinent to current conditions in real time.

Many audio evacuation systems permit multiple messages. For instance, “non fire” messages can be programmed for situations such as a hazardous material spill, gas leaks, security breaches, severe weather, etc.

In the United States, audio evacuation is now required in many jurisdictions for new structures that are classified as an area of assembly, as well as in new high rise buildings and skyscrapers. Retrofitting older structures is not required, although new fire alarm installations can be required to have audio capabilities. Similar trends are occurring in other countries as well.

Currently, in the commercial and residential fire alarm industry the building fire alarm system and building unit smoke detectors are not interconnected. Typically the building fire alarm system is in the building core and the building unit smoke detectors are located in each unit (apartment, condo, hotel room, dormitory room, etc.)

The building fire alarm system generally uses addressable (smart) direct current smoke detectors that provide a description of the location to a main fire alarm control panel. The building fire alarm system is generally provided by a low voltage contractor.

The building unit smoke detectors may be alternating current non-addressable (dumb) detectors that only sound in the building unit itself. This could result in no one in the building knowing that the unit is burning, especially if the tenant isn't home, until the smoke/heat from the unit eventually billows from underneath the door leading to the building core and activates the building alarm system.

Related art that addresses these and other problems includes U.S. Pat. Nos. 4,287,515, 4,394,655, 4,916,432, 5,539,389, 5,598,456, 5,627,515, 6,081,192, 6,960,987, and U.S. published patent applications 2005/0232167 and 2006/0139160.

While these patents, published patent applications and other previous methods have attempted to solve the problems that they addressed, none have utilized or disclosed an addressable alarm detection device capable of operable connection with non-addressable alarm detection devices as well as with an alarm system that polls addressable alarm detection devices to form a hybrid system, as does embodiments of the present invention.

Therefore, a need exists for an alarm system with these attributes and functionalities. The alarm system according to embodiments of the invention substantially departs from the conventional concepts and designs of the prior art. It can be appreciated that there exists a continuing need for a alarm system which can be used commercially. In this regard, the present invention substantially fulfills these objectives.

The foregoing patent and other information reflect the state of the art of which the inventor is aware and are tendered with a view toward discharging the inventor's acknowledged duty of candor in disclosing information that may be pertinent to the patentability of the present invention. It is respectfully stipulated, however, that the foregoing patent and other information do not teach or render obvious, singly or when considered in combination, the inventor's claimed invention.

### BRIEF SUMMARY OF THE INVENTION

In general, in one aspect, the invention features an alarm system where a unit detector is addressable and in communication with other unit detectors that are not addressable located within a particular unit where the addressable unit detector is in communication with the non-addressable unit detectors such that when one unit detector activates, all the other unit detectors in that unit also activate causing communication with the building core detectors and alerting the control room as to the exact location of the alarm condition.

In one implementation, the alarm system is comprised units having at least one unit dumb alarm detector in communication with a unit smart alarm detector, where the smart unit detector is polled by the building alarm system. While the unit dumb alarm detector is generally a 120V detector, other voltages may be used.

In another implementation, the unit detectors may be detectors for smoke, heat, CO2, and flame.

One advantage of the invention is that an addressable detector not only alerts the tenant when something was wrong, but also alerts the building owner/security.

Another advantage of the invention is that it allows a high voltage contractor and a low voltage contractor to merge the two systems together, providing the owner/end user a cost effective solution in residential fire alarm system applications where both tenants and building owner/security office can respond to an emergency faster, knowing precisely which unit has detected a trouble condition.

Other objects, advantages and capabilities of the invention are apparent from the following description taken in conjunction with the accompanying drawings showing the preferred embodiment of the invention.

### BRIEF DESCRIPTION OF THE SEVERAL VIEWS OF THE DRAWINGS

The invention, together with further advantages thereof, may best be understood by reference to the following description of the simplest form of the invention, taken in conjunction with the accompanying drawings in which:

FIG. 1 illustrates a first non-addressable detector in communication with a second non-addressable detector, according to an embodiment of the present invention.

FIG. 2 illustrates a second non-addressable detector in communication with the first non-addressable detector and a third non-addressable detector, according to an embodiment of the present invention.

FIG. 3 illustrates a third non-addressable detector in communication with the second non-addressable detector and an addressable detector, according to an embodiment of the present invention.

FIG. 4 illustrates an addressable detector in communication with the third non-addressable detector and a structure alarm system, according to an embodiment of the present invention.

FIG. 5 illustrates a hybrid system of non-addressable detectors and an addressable detector, according to an embodiment of the present invention.

FIG. 6 illustrates an address setting interface, according to an embodiment of the present invention.

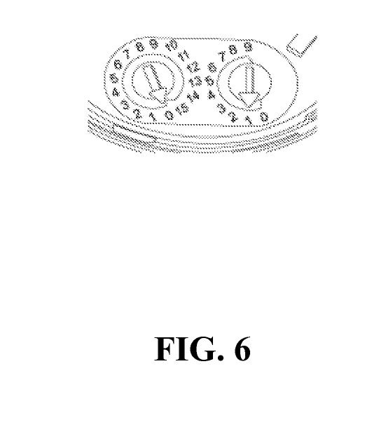

FIG. 7 illustrates a tandem wiring diagram, according to an embodiment of the present invention.

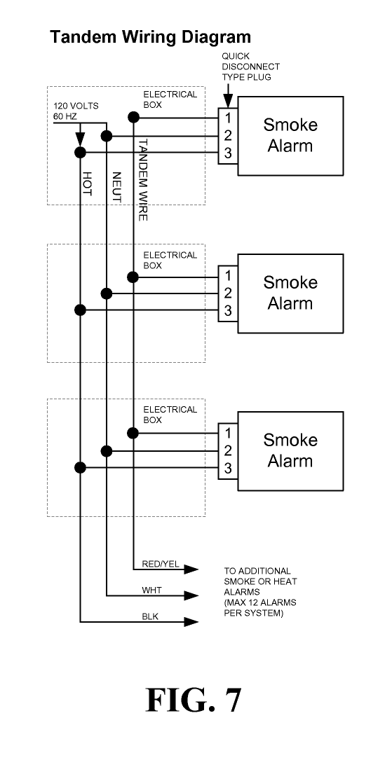

### DETAILED DESCRIPTION OF THE INVENTION

The present invention will now be described in detail with reference to at least one preferred embodiment thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known operations have not been described in detail so not to unnecessarily obscure the present invention.

Referring to the drawings wherein like reference numerals designate corresponding parts throughout the several figures, the following reference numbers are used.

| Reference | |
|---|---|
| Number | Description |
| 1 | A/C Power Connection |
| 2 | Detector Operating Power Module (DOP) |
| 3 | DOP to SM Connection |
| 4 | DOP to OCD Connection |
| 5 | DOP to TIC Connection |
| 6 | Sensing Monitor (SM) |
| 7 | ACS to SM Connection |
| 8 | Alarm Condition Sensor (ACS) |
| 9 | SM to OCD Connection |
| 10 | Tandem Interconnection |
| 11 | Tandem Interface Control (TIC) |
| 12 | TIC to OCD Connection |
| 13 | Output Control Device (OCD) |
| 14 | OCD to SMM Connection |
| 15 | System Monitor Module |
| 16 | Monitor Module Polling Data Circuit |
| 17 | Structure Alarm System |
| 18 | Power Limited Insulation |
| 100 | Non-Addressable Detector |
| 200 | Addressable Detector |
| 300 | Hybrid Alerting System |

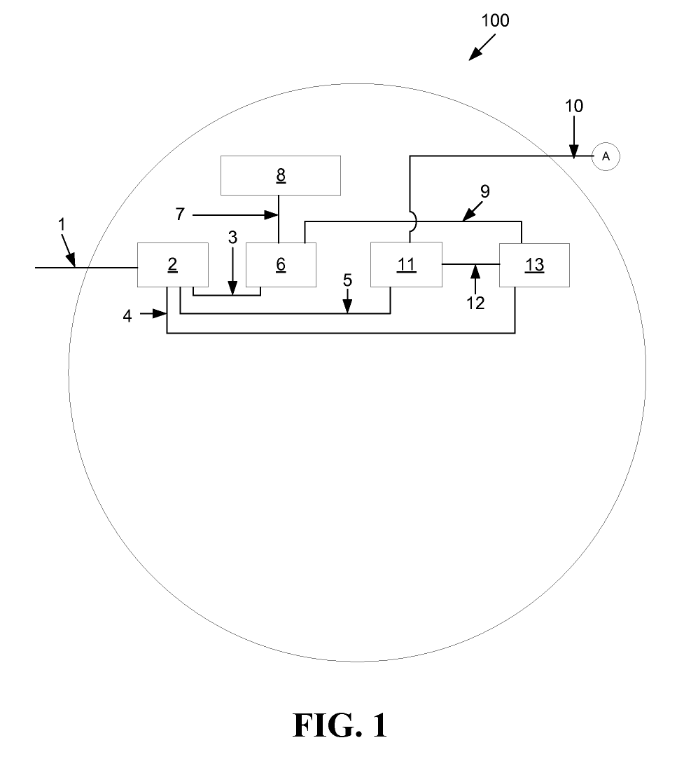

In FIG. 1, non-addressable detector 100 comprises detector operating power module 2 (also called DCP), sensing monitor 6 (also called SM), alarm condition sensor 8 (also called ACS), tandem interface control 11 (also called TIC), output control device 13 (also called OCD).

The DOP 2 is supplied with power from A/C power connection 1. The DOP 2 supplies operating power along the paths of DOP to SM connection 3, DOP to OCD connection 4 and DOP to TIC connection 5.

When the SM 6 receives an alarm condition from ACS 8, the OCD 13 is notified via the path SM to OCD connection 9. Likewise another non-addressable detector 100 may be notified of an alarm condition via the path tandem interconnection 10.

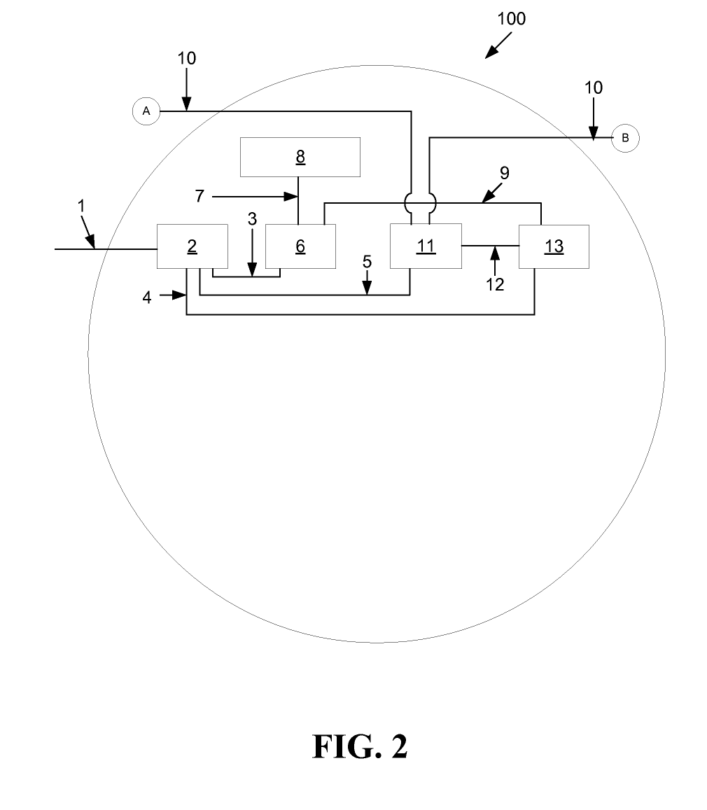

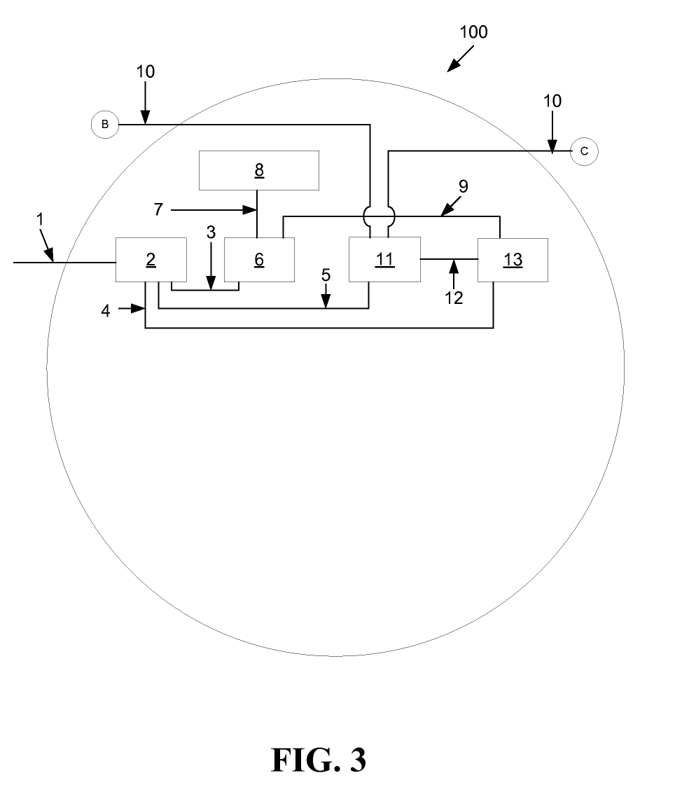

In FIG. 2, a non-addressable detector 100 is capable of receiving an alarm notification along the tandem interconnection 10 from the non-addressable detector 100 of FIG. 1 and notifying the non-addressable detector 100 of FIG. 3 along tandem interconnection 10.

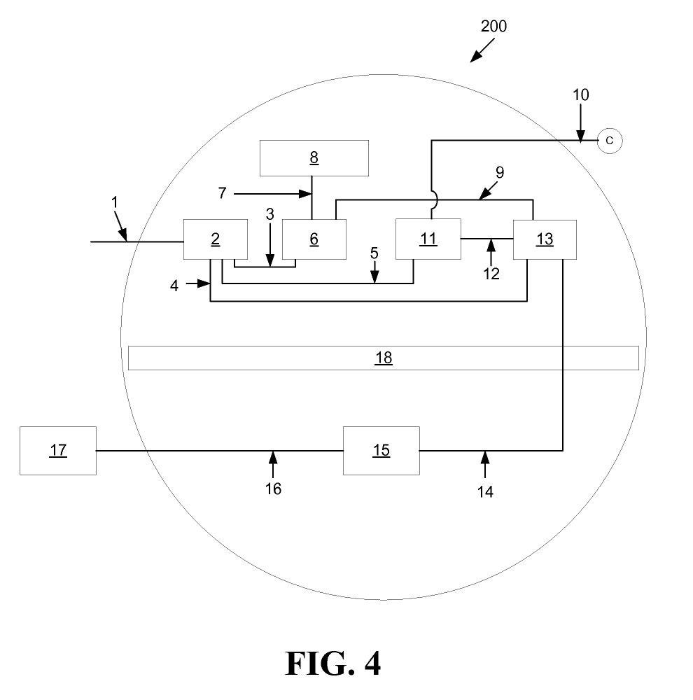

In FIG. 3, a non-addressable detector 100 is capable of receiving an alarm notification along the tandem interconnection 10 from the non-addressable detector 100 of FIG. 2 and notifying the addressable detector 200 of FIG. 4 along tandem interconnection 10.

In FIG. 4, an addressable detector 200 is comprised of the elements of non-addressable detector 100, plus the additional elements of a system monitor module 15 (also known as SMM) that is in communication with OCD 13. Notification of an alarm condition to SMM 15 from OCD 13 occurs via path OCD to SMM connection. 14. This alarm notification may be a result of a trigger from ACS 8 of addressable detector 200 or from notification one of the non-addressable detectors 100 from TIC 11. The alarm system 17 systematically polls addressable detector 200 along monitor module polling data circuit 16. If a trouble condition is detected the address associated with addressable detector 200 is available to alarm system 17, thus identifying the unit location of the trouble.

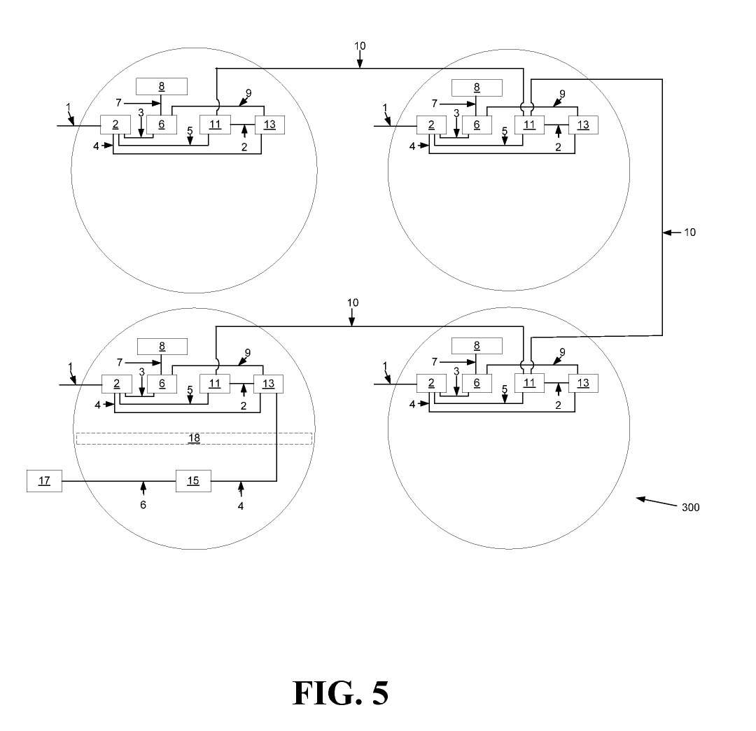

FIG. 5 illustrates the hybrid alerting system 300 described by FIGS. 1-4, showing the non-addressable detector 100 of FIG. 1 connected in tandem to the non-addressable detector 100 of FIG. 2; the non-addressable detector 100 of FIG. 2 connected in tandem to the non-addressable detector 100 of FIG. 3; the non-addressable detector 100 of FIG. 3 connected in tandem to the addressable detector 200 of FIG. 4; and the addressable detector 200 being polled by the structure alarm system 17.

The detector may be powered by different voltages, e.g. 24 volt, 110 volt, 120 volt, 220 volt, depending on the embodiment. These devices may be a smoke detector, a heat detector, a CO2 detector, a thermal detector, a flame detector, a water flow detector, an ADA smoke device, or any other device capable of detecting an alarm condition.

In an exemplary embodiment an addressable alarm condition detector capable of tandem connection with a non-addressable alarm condition detector and polling connection with a polling alarm system, comprises a case molding, a detector operating power module, a sensing monitor, an alarm condition sensor, a first tandem interface control, an output control device, a system monitor module, and a power limited insulation.

The detector operating power module is connected to an alternating current power connection, the sensing monitor, the output control device and the tandem interface control.

The tandem interface control is connected to a tandem interconnection.

The alarm condition sensor is connected to the sensing monitor.

The sensing monitor is connected to the output control device.

The output control device is connected to the system monitor module.

The system monitor module is connected to a monitor module polling data circuit.

The system monitor module is capable of having an address assigned for detection by the polling alarm system, by dip switches, rotary dials, or other address assignment means.

The addressable alarm condition detector may be a smoke detector, a heat detector, a flame detector, a carbon monoxide detector, or another desired alarm condition detector.

In another embodiment the addressable alarm condition detector may be connected to a structure alarm system that is capable of polling the addressable alarm condition detector to form a hybrid alarm system. This connection is accomplished by the monitor module polling data circuit being connected to the structure alarm system.

This hybrid alarm system may further comprise a first non-addressable alarm condition detector having its tandem interface control connected to the tandem interface control of the addressable alarm condition detector.

The hybrid alarm system may further comprise a second non-addressable alarm condition detector having its tandem interface control connected to the tandem interface control of the first non-addressable alarm condition detector.

The hybrid alarm system may further comprise a third non-addressable alarm condition detector having its tandem interface control connected to the tandem interface control of the second non-addressable alarm condition detector.

Additional non-addressable alarm condition detectors may be connected in tandem in a similar manner.

The non-addressable alarm condition detectors may all be for detecting the same alarm condition, e.g. smoke, heat, flame, carbon monoxide, or they may be for detecting different alarm conditions.

The foregoing description and drawings comprise illustrative embodiments of the present invention. Having thus described exemplary embodiments of the present invention, it should be noted by those skilled in the art that the within disclosures are exemplary only, and that various other alternatives, adaptations and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing description and the associated drawings. Although specific terms may be employed herein, they are used in a generic and descriptive sense only and not for purposes of limitation. Accordingly, the present invention is not limited to the specific embodiments illustrated herein, but is limited only by the following claims.

I claim:

1. An addressable alarm condition detector capable of tandem connection with a non-addressable alarm condition detector and polling connection with a polling alarm system, comprising:
a case molding;
a detector operating power module;
a sensing monitor;
an alarm condition sensor;
a first tandem interface control;
an output control device;
a system monitor module; and,
a power limited insulation;
wherein
the detector operating power module is connected to an alternating current power connection, the sensing monitor, the output control device and the tandem interface control,
the tandem interface control is connected to a tandem interconnection,
the alarm condition sensor is connected to the sensing monitor,
the sensing monitor is connected to the output control device,
the output control device is connected to the system monitor module,
the system monitor module is connected to a monitor module polling data circuit,
wherein the system monitor module is capable of having an address assigned for detection by the polling alarm system.

2. The addressable alarm condition detector of claim 1, wherein the addressable alarm detector is a smoke detector.

3. The addressable alarm condition detector of claim 1, wherein the addressable alarm detector is a heat detector.

4. The addressable alarm condition detector of claim 1, wherein the addressable alarm detector is a flame detector.

5. The addressable alarm condition detector of claim 1, wherein the addressable alarm detector is a carbon monoxide detector.

6. A hybrid alarm system containing the addressable alarm condition detector of claim 1, wherein the monitor module polling data circuit is connected to a structure alarm system capable of polling the system monitor module.

7. The hybrid alarm system of claim 6, further comprising a first non-addressable alarm condition detector having a second tandem interface control connected to the first tandem interface control.

8. The hybrid alarm system of claim 7, further comprising a second non-addressable alarm condition detector having a third tandem interface control connected to the second tandem interface control.

9. The hybrid alarm system of claim 8, further comprising a third non-addressable alarm condition detector having a fourth tandem interface control connected to the third tandem interface control.

10. The hybrid alarm system of claim 9, wherein the first non-addressable alarm condition detector, the second non-addressable alarm condition detector and the third non-addressable detector are smoke detectors.

11. The hybrid alarm system of claim 9, wherein the first non-addressable alarm condition detector, the second non-addressable alarm condition detector and the third non-addressable detector are heat detectors.

12. The hybrid alarm system of claim 9, wherein the first non-addressable alarm condition detector, the second non-addressable alarm condition detector and the third non-addressable detector are flame detectors.

13. The hybrid alarm system of claim 9, wherein the first non-addressable alarm condition detector, the second non-addressable alarm condition detector and the third non-addressable detector are carbon monoxide detectors.

14. The hybrid alarm system of claim 9, wherein the first non-addressable alarm condition detector is a smoke detector, the second non-addressable alarm condition detector is a flame detector and the third non-addressable detector is a heat detector.

15. The hybrid alarm system of claim 9, wherein the first non-addressable alarm condition detector is a smoke detector, the second non-addressable alarm condition detector is a flame detector and the third non-addressable detector is a carbon monoxide detector.

16. The hybrid alarm system of claim 9, wherein the first non-addressable alarm condition detector is a smoke detector, the second non-addressable alarm condition detector is a carbon monoxide detector and the third non-addressable detector is a heat detector.

17. The hybrid alarm system of claim 9, wherein the first non-addressable alarm condition detector is a carbon monoxide detector, the second non-addressable alarm condition detector is a flame detector and the third non-addressable detector is a heat detector.

18. The hybrid alarm system of claim 9, wherein the first non-addressable alarm condition detector is a carbon monoxide detector, the second non-addressable alarm condition detector is a smoke detector and the third non-addressable detector is a heat detector.

19. The hybrid alarm system of claim 9, wherein the first non-addressable alarm condition detector is a carbon monoxide detector, the second non-addressable alarm condition detector is a heat detector and the third non-addressable detector is a smoke detector.

20. The hybrid alarm system of claim 9, wherein the first non-addressable alarm condition detector is a heat detector, the second non-addressable alarm condition detector is a flame detector and the third non-addressable detector is a smoke detector.
